(19) United States
(12) Patent Application Publication
(10) Pub. No.: US 2020/0073281 A1
(43) Pub. Date: Mar. 5, 2020

(54) SHEET CONVEYING APPARATUS, DOCUMENT READING APPARATUS, AND IMAGE FORMING APPARATUS

(71) Applicant: CANON KABUSHIKI KAISHA, Tokyo (JP)

(72) Inventor: Yosuke Kagawa, Kashiwa-shi (JP)

(21) Appl. No.: 16/538,511

(22) Filed: Aug. 12, 2019

(30) Foreign Application Priority Data
Aug. 29, 2018 (JP) 2018-160536

(51) Int. Cl. G03G 15/08; G03G 15/02; G03G 15/00

(52) U.S. Cl. CPC G03G 15/0887; G03G 15/0806; G03G 15/5037; G03G 15/0266; G03G 15/0216

(57) ABSTRACT

A sheet conveying apparatus according to the present invention includes a first conveying roller, a second conveying roller, a third conveying roller, a first motor configured to drive the first conveying roller, a phase determiner configured to determine a rotational phase of a rotor of the first motor, a controller configured to control a driving current flowing through a winding of the first motor, and a discriminator configured to, based on the number of times an absolute value of a value of a parameter corresponding to a load torque applied to the rotor changes from a value smaller than a predetermined value to a value greater than the predetermined value, discriminate at least one of whether a front end of a sheet reaches a nip portion of the first conveying roller and whether a rear end of the sheet passes through the nip portion of the first conveying roller.

### BACKGROUND OF THE INVENTION

### Field of the Invention

The present disclosure relates to control of motors in a sheet conveying apparatus, a document reading apparatus, and an image forming apparatus.

### Description of the Related Art

Conventionally, a configuration is discussed in which in an image forming apparatus for forming an image on a sheet, based on a change in a load torque (a fluctuation in load) applied to a rotor of a motor for driving fixing rollers that fix the image to the sheet, it is detected whether the rear end of the sheet comes out of (passes through) a nip portion of the fixing rollers (Japanese Patent Application Laid-Open No. 2000-147851).

Specific examples of a fluctuation in load that occurs in a motor for driving conveying rollers due to the conveyance of a sheet include a fluctuation in load due to the fact that the front end of the sheet reaches a nip portion of the rollers, and a fluctuation in load due to the fact that the rear end of the sheet conveyed by the rollers comes out of a nip portion of rollers upstream of the rollers. Further, specific examples of the fluctuation in load include a fluctuation in load due to the fact that the front end of the sheet conveyed by the rollers reaches a nip portion of rollers downstream of the rollers, and a fluctuation in load due to the fact that the rear end of the sheet conveyed by the rollers comes out of the nip portion of the rollers. Japanese Patent Application Laid-Open No. 2000-147851 does not discuss the cause of such a fluctuation in load. That is, in the configuration of Japanese Patent Application Laid-Open No. 2000-147851, there is a possibility that based on a fluctuation in load other than a fluctuation in load due to the fact that the rear end of the sheet comes out of the nip portion of the fixing rollers, it is determined that the rear end of the sheet comes out of the nip portion of the fixing rollers. That is, there is a possibility that it is erroneously detected that the rear end of the sheet comes out of the nip portion of the fixing rollers.

### SUMMARY OF THE INVENTION

The present disclosure is directed to detecting with high accuracy a sheet that is conveyed.

According to an aspect of the present disclosure, a sheet conveying apparatus includes a first conveying roller configured to convey a sheet, a second conveying roller adjacent to the first conveying roller and provided upstream of the first conveying roller in a conveying direction in which the sheet is conveyed, a third conveying roller adjacent to the first conveying roller and provided downstream of the first conveying roller in the conveying direction, a first motor configured to drive the first conveying roller, a phase determiner configured to determine a rotational phase of a rotor of the first motor, a controller configured to control a driving current flowing through a winding of the first motor, such that a deviation between the rotational phase determined by the phase determiner and an instruction phase indicating a target phase of the rotor is reduced, and a discriminator configured to, based on the number of times an absolute value of a value of a parameter corresponding to a load torque applied to the rotor obtained while the driving current is controlled by the controller changes from a value smaller than a predetermined value to a value greater than the predetermined value, discriminate at least one of whether a front end of the sheet reaches a nip portion of the first conveying roller, and whether a rear end of the sheet passes through the nip portion of the first conveying roller.

Further features of the present disclosure will become apparent from the following description of exemplary embodiments with reference to the attached drawings.

### BRIEF DESCRIPTION OF THE DRAWINGS

FIG. 1 is a cross-sectional view illustrating an image forming apparatus according to a first exemplary embodiment.

FIG. 2 is a block diagram illustrating a control configuration of the image forming apparatus according to the first exemplary embodiment.

FIG. 3 is a diagram illustrating a relationship between a two-phase motor including an A-phase and a B-phase, and a rotating coordinate system represented by a d-axis and a q-axis.

FIG. 4 is a block diagram illustrating a configuration of a motor control device according to the first exemplary embodiment.

FIG. 5 is a diagram illustrating a configuration in which conveying rollers are driven, according to the first exemplary embodiment.

FIG. 6 is a diagram illustrating relationships between sheets that are conveyed and the conveying rollers.

FIG. 7 is a time chart illustrating peripheral velocities of the conveying rollers.

FIG. 8 is a time chart illustrating a deviation output from a motor control device that controls a motor.

FIG. 9 is a flowchart illustrating control performed by a central processing unit (CPU).

FIG. 10 is a diagram illustrating a configuration in which conveying rollers are driven, according to a second exemplary embodiment.

FIG. 11 is a time chart illustrating a deviation output from a motor control device that controls a motor.

FIG. 12 is a block diagram illustrating a configuration of a motor control device that performs velocity feedback control.

FIG. 13 is a block diagram illustrating a configuration of a motor control device that performs phase feedback control and velocity feedback control.

### DESCRIPTION OF THE EMBODIMENTS

With reference to the drawings, suitable exemplary embodiments of the present disclosure will be described below. However, the shapes and the relative arrangement of components described in these exemplary embodiments should be appropriately changed depending on the configuration of an apparatus to which the present disclosure is applied and various conditions, and the scope of the present disclosure is not limited to the following exemplary embodiments. In the following descriptions, a case is described where a motor control device is provided in an image forming apparatus. The motor control device, however, is provided not only in the image forming apparatus. For example, the motor control device is also used in a sheet conveying apparatus for conveying a recording medium or a document such as a sheet.

### [Image Forming Apparatus]

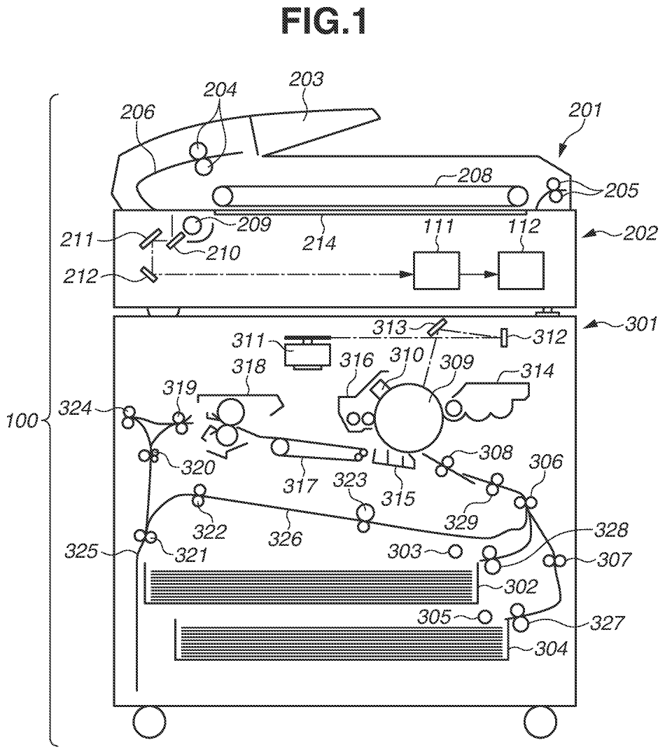

FIG. 1 is a cross-sectional view illustrating the configuration of a monochrome electrophotographic copying machine (hereinafter referred to as “image forming apparatus”) 100 that includes a sheet conveying apparatus used in a first exemplary embodiment. The image forming apparatus 100 is not limited to a copying machine, and may be, for example, a facsimile apparatus, a printing machine, or a printer. The recording method is not limited to an electrophotographic method, and may be, for example, an inkjet method. The format of the image forming apparatus 100 may be either of monochrome and color formats.

With reference to FIG. 1, the configuration and the function of the image forming apparatus 100 are described below. As illustrated in FIG. 1, the image forming apparatus 100 includes a document feeding apparatus 201, a reading apparatus 202, and an image printing apparatus 301.

A document stacked in a document stacking unit 203 of the document feeding apparatus 201 is fed by sheet feeding rollers 204 and conveyed along a conveyance guide 206 onto a document glass platen 214 of the reading apparatus 202. Further, the document is conveyed by a conveying belt 208 and discharged to a sheet discharge tray (not illustrated) by sheet discharge rollers 205. Reflected light from an image on the document illuminated by an illumination system 209 at a reading position of the reading apparatus 202 is guided to an image reading unit 111 by an optical system including reflecting mirrors 210, 211, and 212 and is converted into an image signal by the image reading unit 111. The image reading unit 111 includes a lens, a charge-coupled device (CCD), which is a photoelectric conversion element, and a driving circuit for the CCD. The image signal output from the image reading unit 111 is subjected to various correction processes by an image processing unit 112 that includes a hardware device such as an application-specific integrated circuit (ASIC). Then, the resulting image signal is output to the image printing apparatus 301. As described above, a document is read. That is, the document feeding apparatus 201 and the reading apparatus 202 function as a document reading apparatus.

Document reading modes include a first reading mode and a second reading mode. The first reading mode is a mode where the illumination system 209 and the optical system fixed at predetermined positions read an image on a document conveyed at a constant velocity. The second reading mode is a mode where the illumination system 209 and the optical system moving at a constant velocity read an image on a document placed on the document glass 214 of the reading apparatus 202. Normally, an image on a sheet-like document is read in the first reading mode, and an image on a bound document such as a book or a booklet is read in the second reading mode.

Sheet holding trays 302 and 304 are provided within the image printing apparatus 301. In the sheet holding trays 302 and 304, different types of recording media can be held. For example, A4-size plain paper is held in the sheet holding tray 302, and A4-size thick paper is held in the sheet holding tray 304. On each of the recording media, an image is to be formed by the image forming apparatus 100. For example, the recording media include a sheet, a resin sheet, cloth, an overhead projector (OHP) sheet, and a label.

A recording medium held in the sheet holding tray 302 is fed by a pickup roller 303 and sent out to registration rollers 308 by conveying rollers 306 and 329. A recording medium held in the sheet holding tray 304 is fed by a pickup roller 305 and sent out to the registration rollers 308 by conveying rollers 307 and the conveying rollers 306 and 329.

The image signal output from the reading apparatus 202 is input to an optical scanning device 311 that includes a semiconductor laser and a polygon mirror. The outer peripheral surface of a photosensitive drum 309 is charged by a charging device 310. After the outer peripheral surface of the photosensitive drum 309 is charged, laser light based on the image signal input from the reading apparatus 202 to the optical scanning device 311 is emitted from the optical scanning device 311 to the outer peripheral surface of the photosensitive drum 309 via the polygon mirror and mirrors 312 and 313. Consequently, an electrostatic latent image is formed on the outer peripheral surface of the photosensitive drum 309.

Next, the electrostatic latent image is developed with toner in a developing device 314, thereby forming a toner image on the outer peripheral surface of the photosensitive drum 309. The toner image formed on the photosensitive drum 309 is transferred onto the recording medium by a transfer charging device 315 provided at a position (a transfer position) opposed to the photosensitive drum 309. Based on this transfer timing, the registration rollers 308 send the recording medium into the transfer position.

As described above, the recording medium onto which the toner image has been transferred is sent into a fixing device 318 by a conveying belt 317 and is heated and pressurized by the fixing device 318, thereby fixing the toner image to the recording medium. In this manner, an image is formed on a recording medium by the image forming apparatus 100.

In a case where an image is formed in a one-sided printing mode, the recording medium having passed through the fixing device 318 is discharged to a sheet discharge tray (not illustrated) by sheet discharge rollers 319 and 324. On the other hand, in a case where an image is formed in a two-sided printing mode, a fixing process is performed on a first surface of the recording medium by the fixing device 318, and then, the recording medium is conveyed to a reverse path 325 by the sheet discharge rollers 319, conveying rollers 320, and reverse rollers 321. Then, the recording medium is conveyed to the registration rollers 308 again by conveying rollers 322 and 323, and an image is formed on a second surface of the recording medium by the above method. Then, the recording medium is discharged to the sheet discharge tray (not illustrated) by the sheet discharge rollers 319 and 324.

In a case where the recording medium, on the first surface of which an image is formed, is discharged face down to outside the image forming apparatus 100, the recording medium having passed through the fixing device 318 is conveyed through the sheet discharge rollers 319 in a direction toward the conveying rollers 320. Then, immediately before the rear end of the recording medium passes through a nip portion of the conveying rollers 320, the rotation of the conveying rollers 320 is reversed, thereby discharging the recording medium to outside the image forming apparatus 100 via the sheet discharge rollers 324 in the state where the first surface of the recording medium faces down.

This is the description of the configuration and the function of the image forming apparatus 100. “Loads” in the present exemplary embodiment are target objects to be driven by motors. For example, various rollers (conveying rollers) such as the sheet feeding rollers 204, the pickup rollers 303 and 305, the registration rollers 308, and the sheet discharge rollers 319 correspond to the “loads” in the present exemplary embodiment. The motor control device according to the present exemplary embodiment can be applied to the motors for driving these loads.

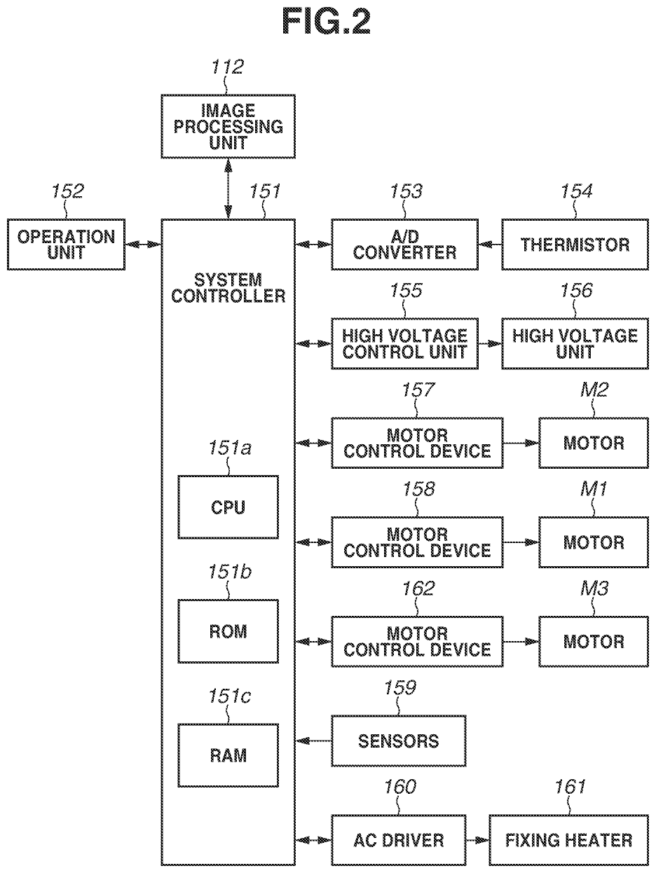

FIG. 2 is a block diagram illustrating an example of the control configuration of the image forming apparatus 100. As illustrated in FIG. 2, a system controller 151 includes a central processing unit (CPU) 151a, a read-only memory (ROM) 151b, and a random-access memory (RAM) 151c. The system controller 151 is connected to the image processing unit 112, an operation unit 152, an analog-to-digital (A/D) converter 153, a high voltage control unit 155, motor control devices 157, 158, and 162, sensors 159, and an alternating current (AC) driver 160. The system controller 151 can transmit and receive data and a command to and from the units connected to the system controller 151.

The CPU 151a reads and executes various programs stored in the ROM 151b, thereby executing various sequences related to an image forming sequence determined in advance.

The RAM 151c is a storage device. The RAM 151c stores various types of data such as a setting value for the high voltage control unit 155, an instruction value for the motor control device 157, and information received from the operation unit 152.

The system controller 151 transmits setting value data, required for image processing by the image processing unit 112, of the various devices provided within the image forming apparatus 100 to the image processing unit 112. Further, the system controller 151 receives signals from the sensors 159, and based on the received signals, sets a setting value of the high voltage control unit 155.

Based on the setting value set by the system controller 151, the high voltage control unit 155 supplies a required voltage to a high voltage unit 156 (the charging device 310, the developing device 314, and the transfer charging device 315).

Based on an instruction output from the CPU 151a, the motor control device 157 controls a motor M2 for driving the conveying rollers 306. Based on an instruction output from the CPU 151a, the motor control device 158 controls a motor M1 for driving the conveying rollers 307. Based on an instruction output from the CPU 151a, the motor control device 162 controls a motor M3 for driving the conveying rollers 329. In FIG. 2, only the motors M1, M2, and M3 are illustrated as motors of the image forming apparatus 100. Actually, however, four or more motors are provided in the image forming apparatus 100. Alternatively, a configuration may be employed in which a single motor control device controls a plurality of motors. Although only three motor control devices are provided in FIG. 2, four or more motor control devices may be provided in the image forming apparatus 100.

The A/D converter 153 receives a signal detected by a thermistor 154 that detects the temperature of a fixing heater 161. Then, the A/D converter 153 converts the detected signal from an analog signal to a digital signal and transmits the digital signal to the system controller 151. Based on the digital signal received from the A/D converter 153, the system controller 151 controls the AC driver 160. The AC driver 160 controls the fixing heater 161 such that the temperature of the fixing heater 161 becomes a temperature required to perform a fixing process. The fixing heater 161 is a heater for use in the fixing process and is included in the fixing device 318.

The system controller 151 controls the operation unit 152 to display, on a display unit provided in the operation unit 152, an operation screen for a user to set the type of a recording medium to be used (hereinafter referred to as the “paper type”). The system controller 151 receives information set by the user from the operation unit 152, and based on the information set by the user, controls the operation sequence of the image forming apparatus 100. Further, the system controller 151 transmits, to the operation unit 152, information indicating the state of the image forming apparatus 100. The information indicating the state of the image forming apparatus 100 is, for example, information regarding the number of images to be formed, the progress state of an image forming operation, and a jam or overlapping feed of a sheet material in the document reading apparatus 202 and the image printing apparatus 301. The operation unit 152 displays on the display unit the information received from the system controller 151.

As described above, the system controller 151 controls the operation sequence of the image forming apparatus 100.

### [Motor Control Device]

Next, the motor control device 157 according to the present exemplary embodiment is described. The motor control device 157 according to the present exemplary embodiment controls a motor using vector control.

### <Vector Control>

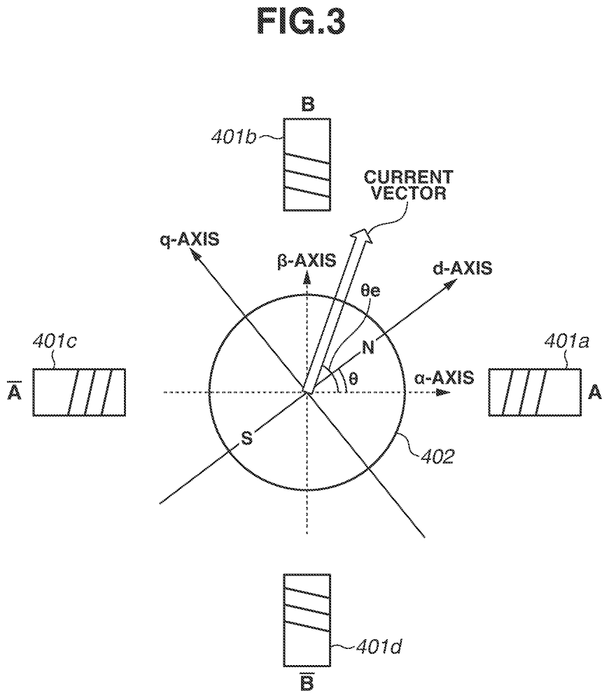

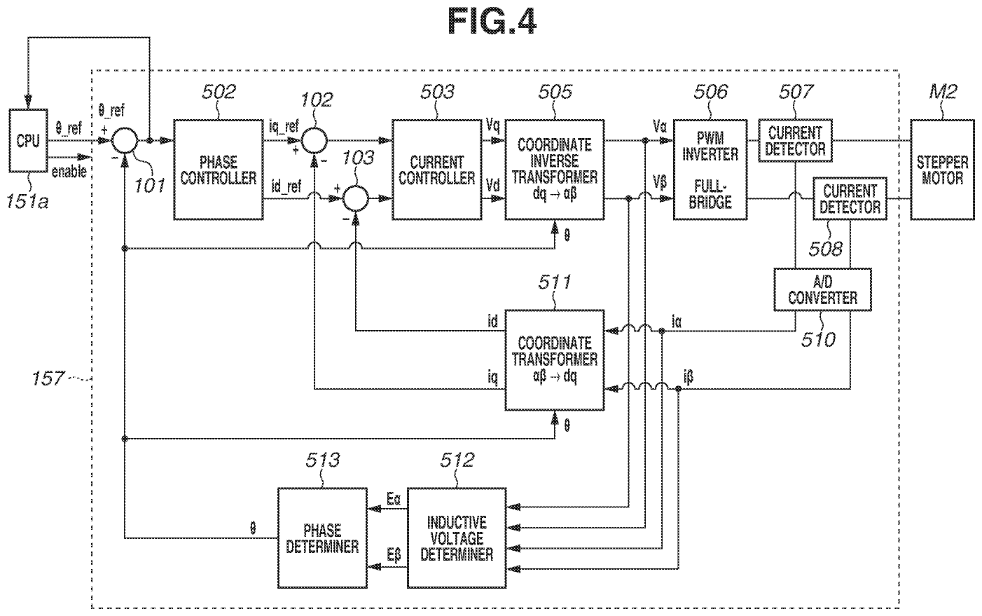

First, with reference to FIGS. 3 and 4, a description is given of a method in which the motor control device 157 performs vector control, according to the present exemplary embodiment. The configurations of the motor control devices 158 and 162 are similar to that of the motor control device 157, and therefore are not described here. Further, in a motor in the following description, a sensor such as a rotary encoder for detecting the rotational phase of a rotor of the motor is not provided. Alternatively, a sensor such as a rotary encoder may be provided.

FIG. 3 is a diagram illustrating the relationship between the stepper motor (hereinafter referred to as “motor”) M2 that has two phases including an A-phase (a first phase) and a B-phase (a second phase), and a rotating coordinate system represented by a d-axis and a q-axis. In FIG. 3, in a stationary coordinate system, an α-axis, which is an axis corresponding to windings in the A-phase, and a β-axis, which is an axis corresponding to windings in the B-phase, are defined. Furthermore, in FIG. 3, the d-axis is defined along the direction of magnetic flux created by the magnetic poles of a permanent magnet used in a rotor 402, and the q-axis is defined along a direction rotated 90 degrees counterclockwise from the d-axis (a direction orthogonal to the d-axis). The angle between the α-axis and the d-axis is defined as θ, and the rotational phase of the rotor 402 is represented by the angle θ. In the vector control, a rotating coordinate system based on the rotational phase θ of the rotor 402 is used. Specifically, in the vector control, a q-axis component (a torque current component) and a d-axis component (an excitation current component), which are current components in the rotating coordinate system of a current vector corresponding to a driving current flowing through each winding, are used. The q-axis component (the torque current component) generates a torque in the rotor 402, and the d-axis component (the excitation current component) influences the strength of magnetic flux passing through the winding.

The vector control is a method for controlling a motor by performing phase feedback control for controlling the value of a torque current component and the value of an excitation current component such that the deviation between an instruction phase indicating a target phase of a rotor and an actual rotational phase of the rotor becomes small. Further, there is also a method for controlling a motor by performing velocity feedback control for controlling the value of a torque current component and the value of an excitation current component such that the deviation between an instruction velocity indicating a target velocity of a rotor and an actual rotational velocity of the rotor becomes small.

FIG. 4 is a block diagram illustrating an example of the configuration of the motor control device 157 that controls the motor M2. The motor control device 157 includes at least one ASIC and executes functions described below.

As illustrated in FIG. 4, the motor control device 157 includes, as a circuit for performing the vector control, a phase controller 502, a current controller 503, a coordinate inverse transformer 505, a coordinate transformer 511, and a pulse-width modulation (PWM) inverter 506 that supplies driving currents to the windings of the motor M2. The coordinate transformer 511 performs coordinate transformation on a current vector corresponding to driving currents flowing through the windings in the A-phase and the B-phase of the motor M2, from the stationary coordinate system represented by the α-axis and the p-axis to the rotating coordinate system represented by the q-axis and the d-axis. Consequently, the driving currents flowing through the windings are represented by the current value of the q-axis component (a q-axis current) and the current value of the d-axis component (a d-axis current), which are current values in the rotating coordinate system. The q-axis current corresponds to a torque current that generates a torque in the rotor 402 of the motor M2. The d-axis current corresponds to an excitation current that influences the strength of magnetic flux passing through the winding of the motor M2. The motor control device 157 can independently control the q-axis current and the d-axis current. Consequently, the motor control device 157 controls the q-axis current based on a load torque applied to the rotor 402 and thereby can efficiently generate a torque required for the rotation of the rotor 402. That is, in the vector control, the magnitude of the current vector illustrated in FIG. 3 changes based on the load torque applied to the rotor 402.

The motor control device 157 determines the rotational phase θ of the rotor 402 of the motor M2 by a method described below, and based on the determination result, performs the vector control. The CPU 151a generates an instruction phase θ_ref that indicates a target phase of the rotor 402 of the motor M2. Then, the CPU 151a outputs the instruction phase θ_ref to the motor control device 157. Actually, the CPU 151a outputs a pulse signal based on a driving sequence determined in advance to the motor control device 157. The number of pulses corresponds to an instruction phase, and the frequency of pulses corresponds to a target velocity.

A subtractor 101 calculates a deviation Δθ between the rotational phase θ of the rotor 402 of the motor M2, which is output from a phase determiner 513, and the instruction phase θ_ref. Then, the subtractor 101 outputs the deviation Δθ.

The phase controller 502 acquires the deviation Δθ in a cycle T (e.g., 200 μs). Based on proportional control (P), integral control (I), and derivative control (D), the phase controller 502 generates a q-axis current instruction value iq_ref and a d-axis current instruction value id_ref such that the deviation Δθ acquired from the subtractor 101 becomes small. Then, the phase controller 502 outputs the q-axis current instruction value iq_ref and the d-axis current instruction value id_ref. Specifically, based on the P-control, the I-control, and the D-control, the phase controller 502 generates the q-axis current instruction value iq_ref and the d-axis current instruction value id_ref such that the deviation Δθ acquired from the subtractor 101 becomes 0. Then, the phase controller 502 outputs the q-axis current instruction value iq_ref and the d-axis current instruction value id_ref. The P-control is a method for controlling the value of a target to be controlled, based on a value proportional to the deviation between an instruction value and an estimated value. The I-control is a method for controlling the value of the target to be controlled, based on a value proportional to the time integral of the deviation between the instruction value and the estimated value. The D-control is a method for controlling the value of the target to be controlled, based on a value proportional to a change over time in the deviation between the instruction value and the estimated value. The phase controller 502 according to the present exemplary embodiment generates the q-axis current instruction value iq_ref and the d-axis current instruction value id_ref based on proportional-integral-derivative (PID) control. The present disclosure, however, is not limited to this. For example, the phase controller 502 may generate the q-axis current instruction value iq_ref and the d-axis current instruction value id_ref based on proportional-integral (PI) control. In the present exemplary embodiment, the d-axis current instruction value id_ref, which influences the strength of magnetic flux passing through the winding, is set to 0. The present disclosure, however, is not limited to this.

Driving currents flowing through the windings in the A-phase and the B-phase of the motor M2 are detected by current detectors 507 and 508 and then converted from analog values to digital values by an A/D converter 510. The cycle in which the current detectors 507 and 508 detect the currents is, for example, a cycle (e.g., 25 μs) less than or equal to the cycle T, in which the phase controller 502 acquires the deviation Δθ.

The current values of the driving currents converted from the analog values to the digital values by the A/D converter 510 are represented as current values iα and iβ in the stationary coordinate system by the following equations, using a phase θe of the current vector illustrated in FIG. 3. The phase θe of the current vector is defined as the angle between the α-axis and the current vector. Further, I represents the magnitude of the current vector.

iα=I*cos θe (1)

iβ=I*sin θe (2)

The current values iα and iβ are input to the coordinate transformer 511 and an inductive voltage determiner 512.

The coordinate transformer 511 transforms the current values iα and iβ in the stationary coordinate system into a current value iq of the q-axis current and a current value id of the d-axis current in the rotating coordinate system by the following equations.

id=cos θ*iα+sin θ*iβ (3)

iq=−sin θ*iα+cos θ*iβ (4)

The coordinate transformer 511 outputs the transformed current value iq to a subtractor 102. Further, the coordinate transformer 511 outputs the transformed current value id to a subtractor 103.

The subtractor 102 calculates the deviation between the q-axis current instruction value iq_ref and the current value iq and outputs the calculated deviation to the current controller 503.

The subtractor 103 calculates the deviation between the d-axis current instruction value id_ref and the current value id and outputs the calculated deviation to the current controller 503.

The current controller 503 generates driving voltages Vq and Vd based on the PID control such that each of the deviations input to the current controller 503 becomes small. Specifically, the current controller 503 generates the driving voltages Vq and Vd such that each of the deviations input to the current controller 503 becomes 0. Then, the current controller 503 outputs the driving voltages Vq and Vd to the coordinate inverse transformer 505. The current controller 503 according to the present exemplary embodiment generates the driving voltages Vq and Vd based on the PID control. The present disclosure, however, is not limited to this. For example, the current controller 503 may generate the driving voltages Vq and Vd based on the PI control.

The coordinate inverse transformer 505 inversely transforms the driving voltages Vq and Vd in the rotating coordinate system, which are output from the current controller 503, into driving voltages Vα and Vβ in the stationary coordinate system by the following equations.

Vα=cos θ*Vd−sin θ*Vq (5)

Vβ=sin θ*Vd+cos θ*Vq (6)

The coordinate inverse transformer 505 outputs the inversely transformed driving voltages Vα and Vβ to the inductive voltage determiner 512 and the PWM inverter 506.

The PWM inverter 506 includes a full-bridge circuit. The full-bridge circuit is driven by PWM signals based on the driving voltages Vα and Vβ input from the coordinate inverse transformer 505. Consequently, the PWM inverter 506 generates driving currents iα and iβ based on the driving voltages Vα and Vβ and supplies the driving currents iα and iβ to the windings in the respective phases of the motor M2, thereby driving the motor M2. In the present exemplary embodiment, the PWM inverter 506 includes a full-bridge circuit. Alternatively, the PWM inverter 506 may include a half-bridge circuit.

Next, a description will be given of a method for determining the rotational phase θ. The rotational phase θ of the rotor 402 is determined using the values of inductive voltages Ea and EP induced in the windings in the A-phase and the B-phase of the motor M2 by the rotation of the rotor 402. The value of each inductive voltage is determined (calculated) by the inductive voltage determiner 512. Specifically, the inductive voltages Eα and Eβ are determined by the following equations, based on the current values iα and iβ input from the A/D converter 510 to the inductive voltage determiner 512 and the driving voltages Vα and Vβ input from the coordinate inverse transformer 505 to the inductive voltage determiner 512.

Eα=Vα−R*iα−L*diα/dt (7)

Eβ=Vp−R*iβ−L*diβ/dt (8)

In these equations, R represents winding resistance, and L represents winding inductance. The values of the winding resistance R and the winding inductance L are values specific to the motor M2 in use and are stored in advance in the ROM 151b or a memory (not illustrated) provided in the motor control device 157.

The inductive voltages Eα and Eβ determined by the inductive voltage determiner 512 are output to the phase determiner 513.

Based on the ratio between the inductive voltages Eα and Eβ output from the inductive voltage determiner 512, the phase determiner 513 determines the rotational phase θ of the rotor 402 of the motor M2 by the following equation.

θ=tan \hat{ }−1(−Eβ/Eα) (9)

In the present exemplary embodiment, the phase determiner 513 determines the rotational phase θ by performing calculation based on the equation (9). The present disclosure, however, is not limited to this. For example, the phase determiner 513 may determine the rotational phase θ by referencing a table stored in the ROM 151b and illustrating the relationships between the inductive voltages Eα and Eβ, and the rotational phase θ corresponding to the inductive voltages Eα and Eβ.

The rotational phase θ of the rotor 402 obtained as described above is input to the subtractor 101, the coordinate inverse transformer 505, and the coordinate transformer 511.

The motor control device 157 repeatedly performs the above control.

As described above, the motor control device 157 according to the present exemplary embodiment performs the vector control for controlling current values in the rotating coordinate system such that the deviation between the instruction phase θ_ref and the rotational phase θ becomes small. The vector control is performed, whereby it is possible to prevent a motor from entering a step-out state, the motor sound from increasing due to an excess torque, and power consumption from increasing.

### [Driving Configuration of Conveying Rollers]

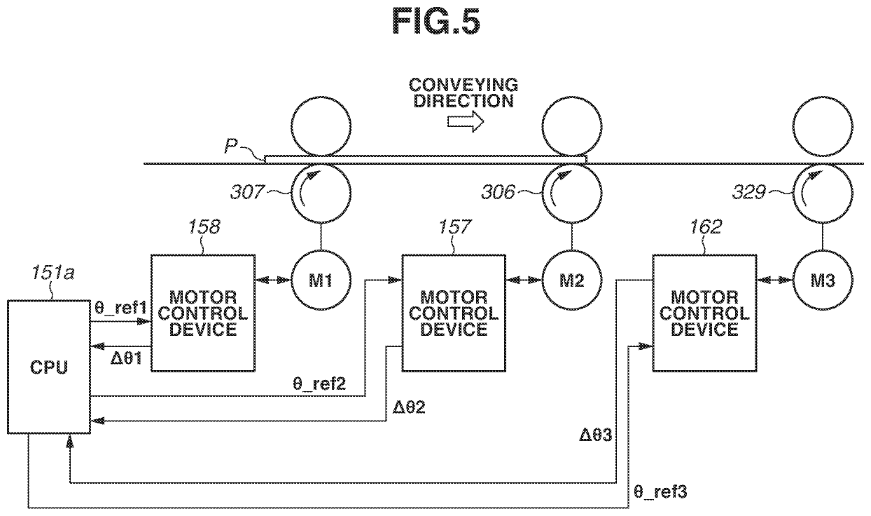

FIG. 5 is a diagram illustrating a configuration in which conveying rollers are driven, according to the present exemplary embodiment. As illustrated in FIG. 5, the conveying rollers 307 are driven by the motor M1, and the motor M1 is controlled by the motor control device 158. The conveying rollers 306 are driven by the motor M2, and the motor M2 is controlled by the motor control device 157. The conveying rollers 329 are driven by the motor M3, and the motor M3 is controlled by the motor control device 162.

The driving configuration of the conveying rollers 306, 307, and 329 is described below. In the following description, the motor control device 158 performs phase feedback control based on an instruction phase θ_ref1 output from the CPU 151a. The motor control device 157 performs phase feedback control based on an instruction phase θ_ref2 output from the CPU 151a. The motor control device 162 performs phase feedback control based on an instruction phase θ_ref3 output from the CPU 151a. The instruction phases are generated by the CPU 151a based on target velocities (driving sequences) of the motors M1, M2, and M3. The target velocities are determined based on target values of the peripheral velocities of rollers.

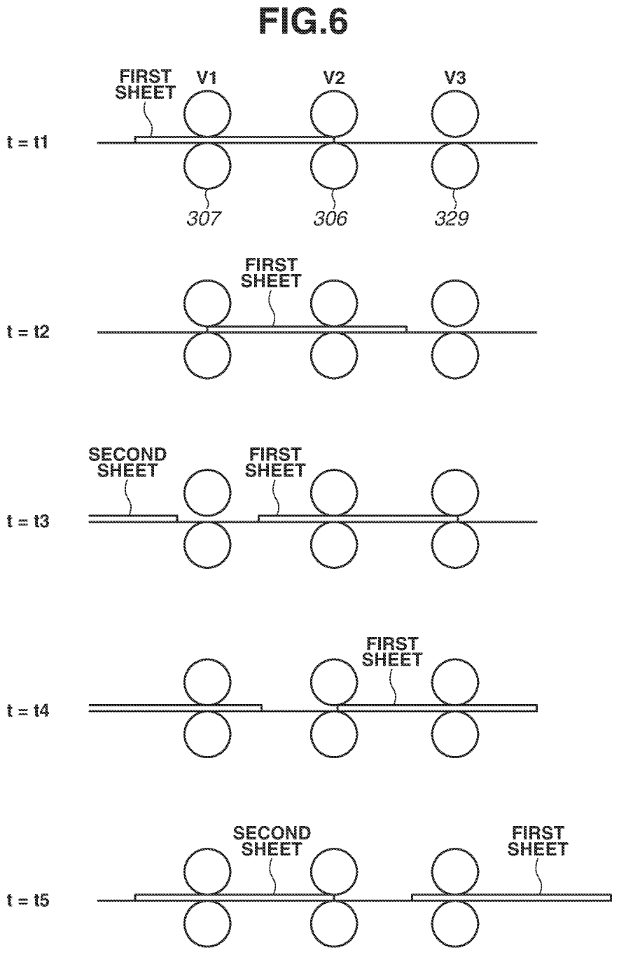

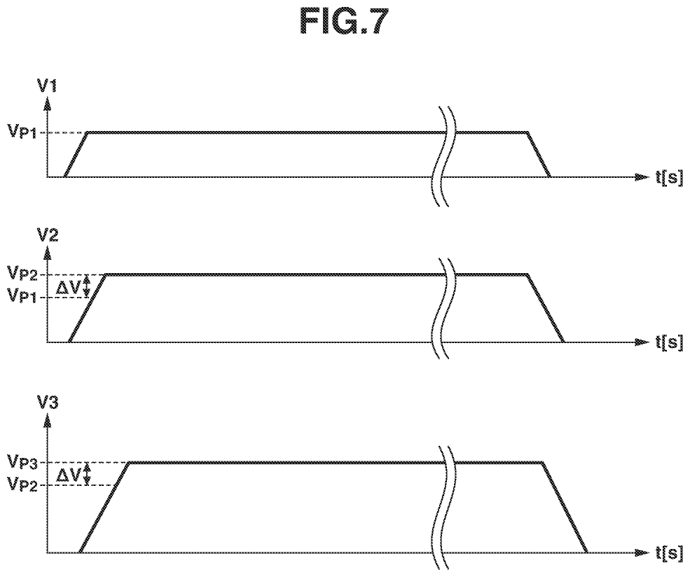

FIG. 6 is a diagram illustrating the relationships between sheets that are conveyed and the conveying rollers 307, 306, and 329. Further, FIG. 7 is a time chart illustrating the peripheral velocities of the conveying rollers. In the present exemplary embodiment, the distance from the front end of an n+1-th sheet to the rear end of an n-th sheet is different in length from the distance from a nip portion of the upstream conveying rollers between two adjacent pairs of conveying rollers to a nip portion of the downstream conveying rollers between the two adjacent pairs of conveying rollers. Further, the distance from the front end of the n+1-th sheet to the front end of the n-th sheet is different in length from the distance from a nip portion of the furthest upstream conveying rollers among three adjacent pairs of conveying rollers to a nip portion of the furthest downstream conveying rollers among the three adjacent pairs of conveying rollers.

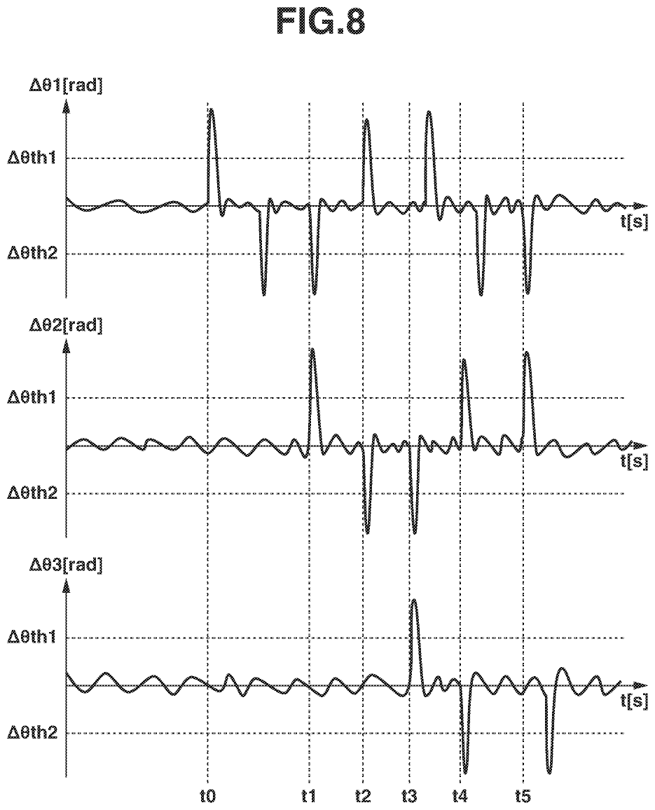

FIG. 8 is a time chart illustrating a deviation Δθ1 as the deviation Δθ output from the motor control device 158, a deviation Δθ2 as the deviation Δθ output from the motor control device 157, and a deviation Δθ3 as the deviation Δθ output from the motor control device 162. In FIG. 8, the deviation Δθ having a positive value means that the rotational phase θ is behind the instruction phase θ_ref. The deviation Δθ having a negative value means that the rotational phase θ is ahead of the instruction phase θ_ref. However, the relationships between the polarity of the deviation Δθ, and the rotational phase θ and the instruction phase θ_ref are not limited to these. For example, a configuration may be employed in which in a case where the rotational phase θ is behind the instruction phase θ_ref, the deviation Δθ has a negative value, and in a case where the rotational phase θ is ahead of the instruction phase θ_ref, the deviation Δθ has a positive value. Further, changes in the deviation Δθ illustrated in FIG. 8 are merely examples. The present disclosure, however, is not limited to this. For example, the fluctuation range of the deviation Δθ at times t1, t2, t3, t4, and t5 does not necessarily have the same size.

As illustrated in FIG. 7, in the present exemplary embodiment, the motor M1 is controlled such that a peripheral velocity V1 of the conveying rollers 307 becomes VP1. The motor M2 is controlled such that a peripheral velocity V2 of the conveying rollers 306 becomes VP2. The motor M3 is controlled such that a peripheral velocity Vβ of the conveying rollers 329 becomes VP3. The conveying rollers 307 rotate at a peripheral velocity faster than that of the conveying rollers 327 adjacent to the conveying rollers 307 and located upstream of the conveying rollers 307.

For example, if a print job is completed, the CPU 151a stops the motors for driving the conveying rollers. The peripheral velocity VP2 is set to a peripheral velocity greater by ΔV than the peripheral velocity VP1. The peripheral velocity VP3 is set to a peripheral velocity greater by ΔV than the peripheral velocity VP2. That is, the conveying rollers downstream in the conveying direction of a sheet rotate at a peripheral velocity faster by ΔV than that of the conveying rollers upstream in the conveying direction. The peripheral velocity of the downstream conveying rollers is set to a peripheral velocity faster than the peripheral velocity of the upstream conveying rollers, whereby the accuracy of detecting the sheet is improved as compared with a case where the upstream conveying rollers and the downstream conveying rollers rotate at the same peripheral velocity. The difference in peripheral velocity ΔV is set to such a difference in peripheral velocity that even if the downstream conveying rollers slip on the surface of the sheet conveyed by the upstream conveying rollers rotating at the peripheral velocity VP1, the sheet is not damaged. In the present exemplary embodiment, for example, the difference in peripheral velocity ΔV in a case where the type of the sheet that is conveyed is thick paper is the same as that in a case where the type of the sheet that is conveyed is thin paper. Alternatively, the difference in peripheral velocity ΔV may be set depending on the type of the sheet that is conveyed. Specifically, the difference in peripheral velocity ΔV corresponding to the thick paper may be smaller than the difference in peripheral velocity ΔV corresponding to the thin paper and the difference in peripheral velocity ΔV corresponding to plain paper. The difference in peripheral velocity ΔV corresponding to the plain paper may be smaller than the difference in peripheral velocity ΔV corresponding to the thin paper.

### [Fluctuation in Load Due to Conveyance of Sheet]

In the state where the conveying rollers 306 rotate at a peripheral velocity faster than that of the conveying rollers 307, and if the conveying rollers 306 nip a sheet conveyed by the conveying rollers 307, the conveying rollers 306 pull the sheet nipped by the conveying rollers 307 downstream. Consequently, a load torque applied to the conveying rollers 306 increases. That is, when the conveying rollers 306 nip the sheet conveyed by the conveying rollers 307, the load torque applied to the conveying rollers 306 increases. This is because a force in a direction opposite to the rotational direction acts on the conveying rollers 306 due to the fact that the conveying rollers 306 pull the sheet nipped by the conveying rollers 307 downstream. If the load torque applied to the conveying rollers 306 becomes great, the absolute value of the deviation Δθ2 becomes great due to the fact that the rotational phase θ of the rotor of the motor M2 for driving the conveying rollers 306 is behind the instruction phase θ_ref.

When the conveying rollers 306 nip the sheet conveyed by the conveying rollers 307, a load torque applied to the conveying rollers 307 decreases. This is because a force in the rotational direction acts on the conveying rollers 307 due to the fact that the sheet nipped by the conveying rollers 307 is pulled by the conveying rollers 306. If the load torque applied to the conveying rollers 307 decreases, the absolute value of the deviation Δθ1 becomes great due to the fact that the rotational phase θ of a rotor of the motor M1 for driving the conveying rollers 307 is ahead of the instruction phase θ_ref.

Specifically, at the time t1 when the front end of the sheet reaches a nip portion of the conveying rollers 306, the absolute values of the deviations Δθ1 and Δθ2 increase as illustrated in FIG. 8.

In the state where the conveying rollers 306 rotate at the peripheral velocity faster than that of the conveying rollers 307, and if the rear end of the sheet nipped by the conveying rollers 306 and the conveying rollers 307 comes out of a nip portion of the conveying rollers 307, the load torque applied to the conveying rollers 306 decreases. This is because the force of the conveying rollers 306 to pull the sheet nipped by the conveying rollers 307 downstream becomes unnecessary. If the load torque applied to the conveying rollers 306 decreases, the absolute value of the deviation Δθ2 becomes great due to the fact that the rotational phase θ of the rotor of the motor M2 for driving the conveying rollers 306 is ahead of the instruction phase θ_ref.

In the state where the conveying rollers 306 rotate at the peripheral velocity faster than that of the conveying rollers 307, and if the rear end of the sheet nipped by the conveying rollers 306 and the conveying rollers 307 comes out of the nip portion of the conveying rollers 307, the load torque applied to the conveying rollers 307 increases. This is because the force in the rotational direction acting on the conveying rollers 307 disappears due to the fact that the sheet nipped by the conveying rollers 307 is pulled by the conveying rollers 306. If the load torque applied to the conveying rollers 307 becomes great, the absolute value of the deviation Δθ1 becomes great due to the fact that the rotational phase θ of the rotor of the motor M1 for driving the conveying rollers 307 is behind the instruction phase θ_ref.

Specifically, at the time t2 when the rear end of the sheet comes out of the nip portion of the conveying rollers 307, the absolute values of the deviations Δθ1 and Δθ2 increase as illustrated in FIG. 8.

Fluctuations in the deviations Δθ2 and Δθ3 at the time t3 in FIG. 8 are fluctuations due to the fact that the front end of the first sheet reaches the conveying rollers 329, and occur for a reason similar to that described at the time t1.

Fluctuations in the deviations Δθ2 and Δθ3 at the time t4 in FIG. 8 are fluctuations due to the fact that the rear end of the first sheet passes through the nip portion of the conveying rollers 306, and occur for a reason similar to that described at the time t2.

Fluctuations in the deviations Δθ1 and Δθ2 at the time t5 in FIG. 8 are fluctuations due to the fact that the front end of the second sheet reaches the conveying rollers 306, and occur for a reason similar to that described at the time t1.

As described above, between when the front end of the n-th sheet reaches the nip portion of the conveying rollers 306 and when the front end of the n+1-th sheet reaches the nip portion of the conveying rollers 306, a fluctuation in the deviation Δθ due to the conveyance of the sheets occurs three times. That is, a fluctuation in load that occurs for a 4*m+1-th time (m is an integer greater than or equal to 0) after a job is started is a fluctuation in load due to the fact that the front end of a sheet reaches the nip portion of the conveying rollers 306.

### [Detection of Sheet]

Next, a description is given of a configuration in which it is detected whether the front end of a sheet reaches (is nipped by) the nip portion of the conveying rollers 306, and whether the rear end of the sheet passes through (comes out of) the nip portion of the conveying rollers 306. In the present exemplary embodiment, not by a sensor such as a photosensor but based on a signal output from each motor control device, it is detected (determined) whether the front end of the sheet reaches the nip portion of the conveying rollers 306.

In the present exemplary embodiment, as thresholds for the deviation Δθ, a threshold Δθth1 having a positive value and a threshold Δθth2 having a negative value are set. The polarities of the thresholds Δθth1 and Δθth2 are opposite to each other, and the absolute values of the thresholds Δθth1 and Δθth2 may be the same value or different values.

In the present exemplary embodiment, the thresholds Δθth1 and Δθth2 are set based on, among a plurality of types of sheets that can be conveyed in the image forming apparatus 100, the type of a sheet that causes the smallest fluctuation in load due to the conveyance of the sheet. Specifically, for example, in a case where the types of sheets that can be conveyed in the image forming apparatus 100 are thick paper, plain paper, and thin paper, a fluctuation in load occurring in the conveying rollers when the front end of the thick paper is conveyed is greater than a fluctuation in load occurring in the conveying rollers when the plain paper or the thin paper is conveyed. The fluctuation in load occurring in the conveying rollers when the plain paper is conveyed is greater than the fluctuation in load occurring in the conveying rollers when the thin paper is conveyed. Thus, the thresholds Δθth1 and Δθth2 are set based on the magnitude of the fluctuation in load due to the conveyance of the thin paper.

The threshold Δθth1 is set to, for example, a value greater than the deviation Δθ assumed in the state where the thin paper (the sheet) is not nipped by the nip portion of the conveying rollers 306 and also the state where the conveying rollers 306 rotate at a constant velocity. Further, the threshold Δθth1 is set to a value smaller than the maximum value (a peak value) of the deviation Δθ that increases due to the fact that the front end of the thin paper (the sheet) conveyed by the conveying rollers 307 is nipped by the conveying rollers 306. Furthermore, the threshold Δθth1 is set to a value smaller than the maximum value (a peak value) of the deviation Δθ that increases due to the fact that the rear end of the thin paper (the sheet) conveyed by the conveying rollers 306 comes out of a nip portion of the conveying rollers 306.

The threshold Δθth2 is set to, for example, a value greater than the absolute value of the deviation Δθ assumed in the state where the thin paper (the sheet) is not nipped by the nip portion of the conveying rollers 306 and also the state where the conveying rollers 306 rotate at a constant velocity. Further, the threshold Δθth2 is set to a value smaller than the maximum value (a peak value) of the absolute value of the deviation Δθ that increases due to the fact that the rear end of the thin paper (the sheet) conveyed by the conveying rollers 306 and 307 comes out of the nip portion of the conveying rollers 307. Furthermore, the threshold Δθth2 is set to a value smaller than the maximum value (a peak value) of the absolute value of the deviation Δθ that increases due to the fact that the front end of the thin paper (the sheet) conveyed by the conveying rollers 306 is nipped by the nip portion of the conveying rollers 329.

Every time the CPU 151a acquires the deviations Δθ1, Δθ2, and Δθ3 output from the motor control devices 157, 158, and 162, respectively, the CPU 151a stores the acquired deviations in the RAM 151c in association with the timings when the deviations are acquired. Based on the deviation Δθ2 output from the motor control device 157 and the deviation Δθ3 output from the motor control device 162, the CPU 151a detects the sheet.

Specifically, when the deviation Δθ2 becomes greater than or equal to the threshold Δθth1, and if the absolute value of the deviation Δθ3 is smaller than the absolute value of the threshold Δθth2, the CPU 151a determines that the fluctuation in the deviation Δθ2 is due to the fact that the front end of the sheet reaches the nip portion of the conveying rollers 306. More specifically, when the deviation Δθ2 becomes greater than or equal to the threshold Δθth1, and if the deviation Δθ3 is greater than the threshold Δθth2, the CPU 151a determines that the fluctuation in the deviation Δθ2 is due to the fact that the front end of the sheet reaches the nip portion of the conveying rollers 306.

In a configuration in which in a case where the rotational phase θ is behind the instruction phase θ_ref, the deviation Δθ has a negative value, and in a case where the rotational phase θ is ahead of the instruction phase θ_ref, the deviation Δθ has a positive value, the determination is made as follows. Specifically, when the deviation Δθ2 becomes less than or equal to the threshold Δθth2, and if the deviation Δθ3 is smaller than the threshold Δθth1, the CPU 151a determines that the fluctuation in the deviation Δθ2 is due to the fact that the front end of the sheet reaches the nip portion of the conveying rollers 306.

When the deviation Δθ2 becomes greater than or equal to the threshold Δθth1, and if the absolute value of the deviation Δθ3 is greater than or equal to the absolute value of the threshold Δθth2, the CPU 151a determines that the fluctuation in the deviation Δθ2 is due to the fact that the rear end of the sheet passes through the nip portion of the conveying rollers 306. More specifically, when the deviation Δθ2 becomes greater than or equal to the threshold Δθth1, and if the deviation Δθ3 is less than or equal to the threshold Δθth2, the CPU 151a determines that the fluctuation in the deviation Δθ2 is due to the fact that the rear end of the sheet passes through the nip portion of the conveying rollers 306.

In a configuration in which in a case where the rotational phase θ is behind the instruction phase θ_ref, the deviation Δθ has a negative value, and in a case where the rotational phase θ is ahead of the instruction phase θ_ref, the deviation Δθ has a positive value, the determination is made as follows. Specifically, when the deviation Δθ2 becomes less than or equal to the threshold Δθth2, and if the deviation Δθ3 is greater than or equal to the threshold Δθth1, the CPU 151a determines that the fluctuation in the deviation Δθ2 is due to the fact that the rear end of the sheet passes through the nip portion of the conveying rollers 306.

Even if a predetermined time elapses since it has been detected that the front end of the n-th sheet reaches the nip portion of the conveying rollers 306, but if it is not detected that the front end of the n+1-th sheet reaches the nip portion of the conveying rollers 306, the CPU 151a displays, on the display unit of the operation unit 152, information indicating that an abnormality (e.g., a jam) occurs in the conveyance of a sheet. Further, the CPU 151a stops the driving of the conveying rollers. With the use of such a configuration, it is possible to prevent conveying rollers from being driven in the state where a sheet is not normally conveyed. Consequently, it is possible to prevent the conveying rollers or the sheet from being damaged, and power consumption from increasing. The predetermined time is set to a time longer than the time required from the time when the front end of the n-th sheet reaches the nip portion of the conveying rollers 306 to the time when the front end of the n+1-th sheet should reach the nip portion of the conveying rollers 306.

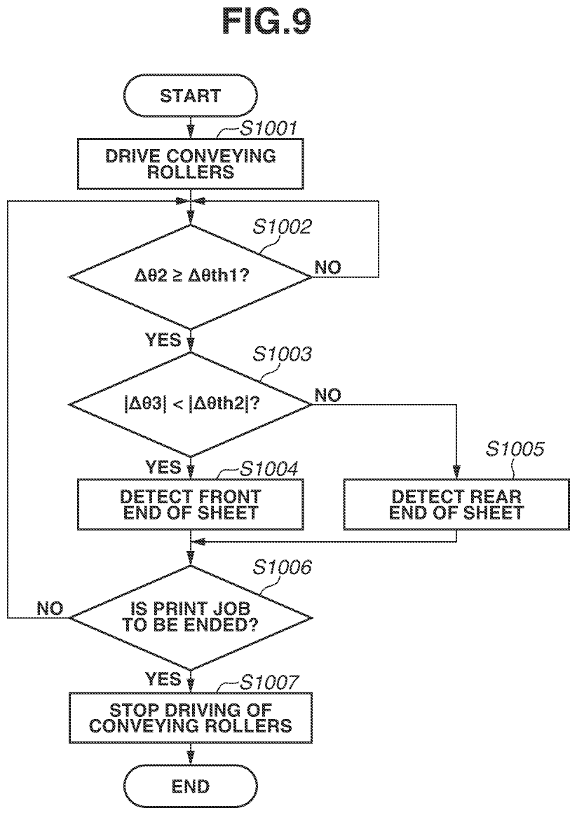

FIG. 9 is a flowchart illustrating control performed by the CPU 151a. With reference to FIG. 9, the control performed by the CPU 151a according to the present exemplary embodiment is described below. The processing of the flowchart is executed by the CPU 151a.

If a print job is started, then in step S1001, the CPU 151a controls the motors for driving the conveying rollers (the conveying rollers 307, 306, and 329) to start driving the conveying rollers. Consequently, the conveying rollers 307 are driven at the peripheral velocity VP1, the conveying rollers 306 are driven at the peripheral velocity VP2, and the conveying rollers 329 are driven at the peripheral velocity VP3.

Next, in step S1002, if the deviation Δθ2 is greater than or equal to the threshold Δθth1 (YES in step S1002), the processing proceeds to step S1003.

In step S1003, if the absolute value of the deviation Δθ3 is smaller than the absolute value of the threshold Δθth2 (YES in step S1003), then in step S1004, the CPU 151a determines that the fluctuation in the deviation Δθ2 is due to the fact that the front end of a sheet reaches the nip portion of the conveying rollers 306.

In step S1003, if the absolute value of the deviation Δθ3 is greater than or equal to the absolute value of the threshold Δθth2 (NO in step S1003), then in step S1005, the CPU 151a determines that the fluctuation in the deviation Δθ2 is due to the fact that the rear end of the sheet passes through (comes out of) the nip portion of the conveying rollers 306.

Then, in step S1006, if the print job is to be continued (NO in step S1006), the processing returns to step S1002.

In step S1006, if the print job is to be ended (YES in step S1006), then in step S1007, the CPU 151a stops the driving of the conveying rollers (the conveyance of the sheet) and ends the processing of the flowchart.

As described above, in the present exemplary embodiment, motors for driving conveying rollers are controlled such that conveying rollers downstream in a conveying direction rotate at a peripheral velocity faster than that of conveying rollers upstream in the conveying direction. Specifically, the conveying rollers 306 are driven at the peripheral velocity VP2 faster than the peripheral velocity VP1 of the conveying rollers 307. Further, the conveying rollers 329 are driven at the peripheral velocity VP3 faster than the peripheral velocity VP2 of the conveying rollers 306. The downstream conveying rollers are rotated at the peripheral velocity faster than that of the upstream conveying rollers, whereby it is possible to make the fluctuation range of a load torque applied to a motor for driving conveying rollers due to the conveyance of a sheet large. That is, it is possible to make the fluctuation range of the deviation Δθ large.

Then, when the deviation Δθ2 becomes greater than or equal to the threshold Δθth1, and if the absolute value of the deviation Δθ3 is smaller than the absolute value of the threshold Δθth2, the CPU 151a determines that the fluctuation in the deviation Δθ2 is due to the fact that the front end of the sheet reaches the nip portion of the conveying rollers 306. When the deviation Δθ2 becomes greater than or equal to the threshold Δθth1, and if the absolute value of the deviation Δθ3 is greater than or equal to the absolute value of the threshold Δθth2, the CPU 151a determines that the fluctuation in the deviation Δθ2 is due to the fact that the rear end of the sheet passes through the nip portion of the conveying rollers 306. That is, in the present exemplary embodiment, based on a deviation in a motor for driving conveying rollers used to detect a sheet and a deviation in a motor for driving conveying rollers downstream of the conveying rollers, a sheet is detected. Consequently, it is possible to prevent the determination that the front end of a sheet reaches the nip portion of the conveying rollers 306, based on a fluctuation in load other than a fluctuation in load due to the fact that the front end of the sheet reaches the nip portion of the conveying rollers 306. That is, it is possible to detect with high accuracy a sheet that is conveyed.

As described above, in the present exemplary embodiment, not by a sensor such as a photosensor but based on a signal output from each motor control device, a sheet is detected. Consequently, it is possible to detect a sheet with high accuracy while preventing an increase in the size of an image forming apparatus (a sheet conveying apparatus) and an increase in cost.

In the present exemplary embodiment, based on a deviation in a motor for driving conveying rollers used to detect a sheet and a deviation in a motor for driving conveying rollers downstream of the conveying rollers, a sheet is detected. The present disclosure, however, is not limited to this. For example, based on a deviation in a motor for driving conveying rollers used to detect a sheet and a deviation in a motor for driving conveying rollers upstream of the conveying rollers, a sheet may be detected.

Specifically, for example, when the deviation Δθ2 becomes greater than or equal to the threshold Δθth1, and if the absolute value of the deviation Δθ1 is greater than or equal to the absolute value of the threshold Δθth2, the CPU 151a determines that the fluctuation in the deviation Δθ2 is due to the fact that the front end of the sheet reaches the nip portion of the conveying rollers 306. More specifically, when the deviation Δθ2 becomes greater than or equal to the threshold Δθth1, and if the deviation Δθ1 is less than or equal to the threshold Δθth2, the CPU 151a determines that the fluctuation in the deviation Δθ2 is due to the fact that the front end of the sheet reaches the nip portion of the conveying rollers 306.

In a configuration in which in a case where the rotational phase θ is behind the instruction phase θ_ref, the deviation Δθ has a negative value, and in a case where the rotational phase θ is ahead of the instruction phase θ_ref, the deviation Δθ has a positive value, the determination is made as follows. Specifically, when the deviation Δθ2 becomes less than or equal to the threshold Δθth2, and if the deviation Δθ1 is greater than or equal to the threshold Δθth1, the CPU 151a determines that the fluctuation in the deviation Δθ2 is due to the fact that the front end of the sheet reaches the nip portion of the conveying rollers 306.

When the deviation Δθ2 becomes greater than or equal to the threshold Δθth1, and if the absolute value of the deviation Δθ1 is smaller than the absolute value of the threshold Δθth2, the CPU 151a determines that the fluctuation in the deviation Δθ2 is due to the fact that the rear end of the sheet passes through the nip portion of the conveying rollers 306. More specifically, when the deviation Δθ2 becomes greater than or equal to the threshold Δθth1, and if the deviation Δθ1 is greater than the threshold Δθth2, the CPU 151a determines that the fluctuation in the deviation Δθ2 is due to the fact that the rear end of the sheet passes through the nip portion of the conveying rollers 306.

In a configuration in which in a case where the rotational phase θ is behind the instruction phase θ_ref, the deviation Δθ has a negative value, and in a case where the rotational phase θ is ahead of the instruction phase θ_ref, the deviation Δθ has a positive value, the determination is made as follows. Specifically, when the deviation Δθ2 becomes less than or equal to the threshold Δθth2, and if the deviation Δθ1 is smaller than the threshold Δθth1, the CPU 151a determines that the fluctuation in the deviation Δθ2 is due to the fact that the rear end of the sheet passes through the nip portion of the conveying rollers 306.

A second exemplary embodiment is described. A configuration similar to that of the first exemplary embodiment is not described here.

### [Driving Configuration of Conveying Rollers]

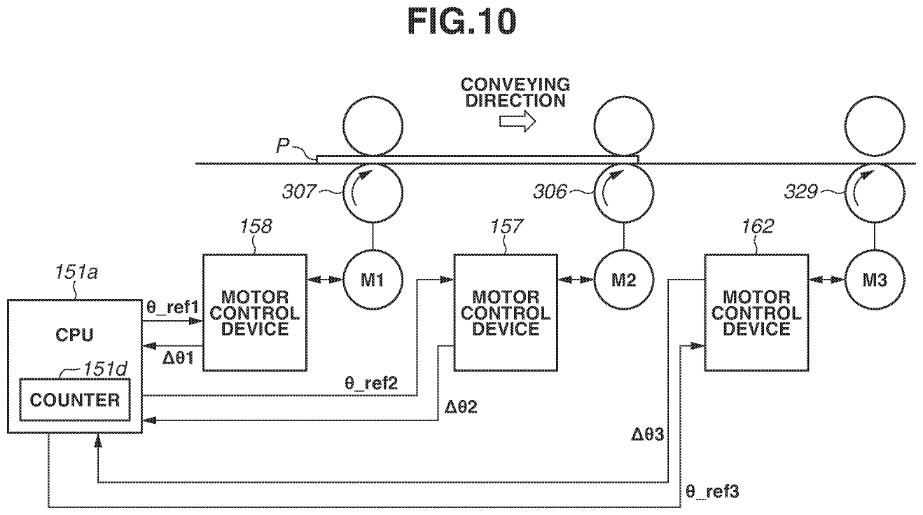

FIG. 10 is a diagram illustrating a configuration in which conveying rollers are driven, according to the present exemplary embodiment. As illustrated in FIG. 10, the conveying rollers 307 are driven by the motor M1, and the motor M1 is controlled by the motor control device 158. The conveying rollers 306 are driven by the motor M2, and the motor M2 is controlled by the motor control device 157. The conveying rollers 329 are driven by the motor M3, and the motor M3 is controlled by the motor control device 162. The CPU 151a includes a counter 151d that collectively counts the number of times the deviation Δθ2 becomes greater than the threshold Δθth1, and the number of times the deviation Δθ2 becomes smaller than the threshold Δθth2.

### [Detection of Sheet]

Next, a description is given of a configuration in which it is detected whether the front end of a sheet reaches (is nipped by) the nip portion of the conveying rollers 306. In the present exemplary embodiment, not by a sensor such as a photosensor but based on a signal output from each motor control device, it is detected (determined) whether the front end of the sheet reaches the nip portion of the conveying rollers 306.

The CPU 151a causes the counter 151d to count the number of times the deviation Δθ2 becomes greater than the threshold Δθth1, and the number of times the deviation Δθ2 becomes smaller than the threshold Δθth2. The CPU 151a determines that the timing when the count value of the counter 151d becomes 4*(m−1)+1 (m is a positive integer) is the timing when the front end of an m-th sheet reaches the nip portion of the conveying rollers 306.

After the CPU 151a determines that the front end of the m-th sheet reaches the nip portion of the conveying rollers 306, and if the state where it is not determined that the front end of an m+1-th sheet reaches the nip portion of the conveying rollers 306 continues for a predetermined time, the CPU 151a displays, on the display unit of the operation unit 152, information indicating that an abnormality (e.g., a jam) occurs in the conveyance of a sheet. Further, the CPU 151a stops the driving of the conveying rollers. With the use of such a configuration, it is possible to prevent conveying rollers from being driven in the state where a sheet is not normally conveyed. Consequently, it is possible to prevent the conveying rollers or the sheet from being damaged, and power consumption from increasing. The predetermined time is set to a time longer than the time required from the time when the front end of the m-th sheet reaches the nip portion of the conveying rollers 306 to the time when the front end of the m+1-th sheet should reach the nip portion of the conveying rollers 306.

As described above, in the present exemplary embodiment, motors for driving conveying rollers are controlled such that conveying rollers downstream in a conveying direction rotate at a peripheral velocity faster than that of conveying rollers upstream in the conveying direction. Specifically, the conveying rollers 306 are driven at the peripheral velocity VP2 faster than the peripheral velocity VP1 of the conveying rollers 307. Further, the conveying rollers 329 are driven at the peripheral velocity VP3 faster than the peripheral velocity VP2 of the conveying rollers 306. The downstream conveying rollers are rotated at the peripheral velocity faster than that of the upstream conveying rollers, whereby it is possible to make the fluctuation range of a load torque applied to a motor for driving conveying rollers due to the conveyance of a sheet large. That is, it is possible to make the fluctuation range of the deviation Δθ large.

Then, the CPU 151a causes the counter 151d to count the number of times the deviation Δθ2 becomes greater than the threshold Δθth1, and the number of times the deviation Δθ2 becomes smaller than the threshold Δθth2. The CPU 151a determines that the timing when the count value of the counter 151d becomes 4*(m−1)+1 is the timing when the front end of the m-th sheet reaches the nip portion of the conveying rollers 306. Consequently, it is possible to prevent the determination that the front end of a sheet reaches the nip portion of the conveying rollers 306, based on a fluctuation in load other than a fluctuation in load due to the fact that the front end of the sheet reaches the nip portion of the conveying rollers 306. That is, it is possible to detect with high accuracy a sheet that is conveyed.

As described above, in the present exemplary embodiment, not by a sensor such as a photosensor but based on a signal output from the motor control device 157, a sheet is detected. Consequently, it is possible to detect a sheet with high accuracy while preventing an increase in the size of an image forming apparatus (a sheet conveying apparatus) and an increase in cost.

In the present exemplary embodiment, the CPU 151a causes the counter 151d to count the number of times the deviation Δθ2 becomes greater than the threshold Δθth1, and the number of times the deviation Δθ2 becomes smaller than the threshold Δθth2. The present disclosure, however, is not limited to this. For example, a configuration may be employed in which the CPU 151a causes the counter 151d to count the number of times the deviation Δθ2 becomes greater than the threshold Δθth1. In this case, the CPU 151a determines that the timing when the count value of the counter 151d becomes 2*(m−1)+1 (m is a positive integer) is the timing when the front end of the m-th sheet reaches the nip portion of the conveying rollers 306.

The configuration of the present exemplary embodiment is also applied to a configuration in which it is detected whether the rear end of the sheet passes through the nip portion of the conveying rollers 306. Specifically, the CPU 151a determines that the timing when the count value of the counter 151d becomes 4*m (m is a positive integer) is the timing when the rear end of the m-th sheet passes through the nip portion of the conveying rollers 306. Alternatively, a configuration may be employed in which the CPU 151 la causes the counter 151d to count the number of times the deviation Δθ2 becomes greater than the threshold Δθth1. In this case, the CPU 151a determines that the timing when the count value of the counter 151d becomes 2*m (m is a positive integer) is the timing when the front end of the m-th (m is a positive integer) sheet reaches the nip portion of the conveying rollers 306.

In the first and second exemplary embodiments, the thresholds for the deviation Δθ are predetermined values, regardless of the paper type. Alternatively, the thresholds may be set with respect to each paper type.

The configuration of the present exemplary embodiment (i.e., a configuration in which a sheet is detected based on a signal output from the motor control device 157) is applied not only to the conveying rollers 307, 306, and 329, but also to adjacent (adjoining) pairs of conveying rollers.

Further, in the first and second exemplary embodiments, the difference in velocity between VP1 and VP2 and the difference in velocity between VP2 and VP3 may be different from each other.

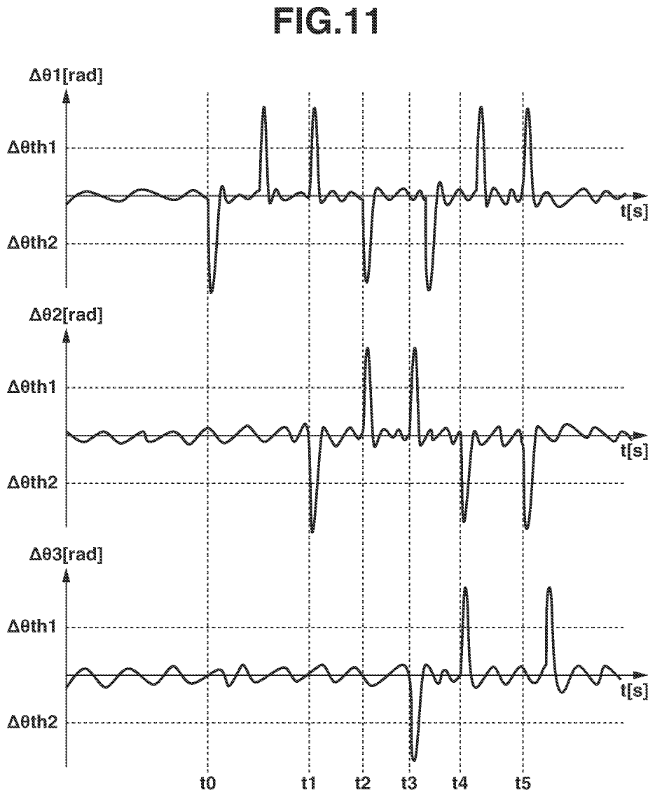

In the first and second exemplary embodiments, the CPU 151a controls the driving of the conveying rollers such that the peripheral velocity of the conveying rollers downstream in the conveying direction becomes faster than that of the conveying rollers upstream in the conveying direction. The present disclosure, however, is not limited to this. For example, a configuration may be employed in which the conveying rollers are controlled such that the peripheral velocity of the downstream conveying rollers becomes slower than that of the upstream conveying rollers. In this case, if the front end of a sheet reaches a nip portion of the downstream conveying rollers, the sheet bends between the upstream and downstream conveying rollers due to the fact that the upstream conveying rollers are faster than the downstream conveying rollers. Consequently, an elastic force acts on the sheet. Due to the elastic force, a force in a direction opposite to the rotational direction acts on the upstream conveying rollers. Consequently, a load torque applied to a motor for driving the upstream conveying rollers increases. A force in the rotational direction due to the elastic force acts on the downstream conveying rollers. Consequently, a load torque applied to a motor for driving the downstream conveying rollers decreases. When the rear end of the sheet comes out of a nip portion of the upstream conveying rollers, the force in the direction opposite to the rotational direction due to the elastic force disappears. Thus, the load torque applied to the motor for driving the upstream conveying rollers decreases. Further, when the rear end of the sheet comes out of the nip portion of the upstream conveying rollers, the force in the rotational direction due to the elastic force becomes small. Thus, the load torque applied to the motor for driving the downstream conveying rollers increases. Specifically, if the conveying rollers are controlled such that the peripheral velocity of the downstream conveying rollers becomes slower than that of the upstream conveying rollers, the deviation Δθ changes as in FIG. 11. As described above, in the state where the conveying rollers are controlled such that the peripheral velocity of the downstream conveying rollers becomes slower than that of the upstream conveying rollers, a sheet may be detected by the methods described in the first and second exemplary embodiments based on the deviation Δθ in the motor for driving the upstream or downstream conveying rollers.

In the first and second exemplary embodiments, a sheet is detected by comparing the absolute value of the deviation Δθ with a threshold Δθth. The present disclosure, however, is not limited to this. For example, a sheet may be detected by comparing the current value iq output from the coordinate transformer 511 with a threshold iqth. The current value iq increasing means that the load torque applied to the rotor of the motor increases. The current value iq decreasing means that the load torque applied to the rotor of the motor decreases.

Further, a sheet may be detected by comparing the q-axis current instruction value (target value) iq_ref with a threshold iq_refth determined based on the deviation between the instruction phase θ_ref and the rotational phase θ determined by the phase determiner 513. The q-axis current instruction value iq_ref increasing means that a torque required for the rotation of the rotor of the motor increases due to an increase in the load torque applied to the rotor. The q-axis current instruction value iq_ref decreasing means that the torque required for the rotation of the rotor of the motor decreases due to a decrease in the load torque applied to the rotor.

Further, a configuration may be employed in which a sheet is detected by comparing the amplitude (magnitude) of the current value iα or iβ in the stationary coordinate system with a threshold. The amplitude (magnitude) of the current value iα or iβ in the stationary coordinate system increasing means that the load torque applied to the rotor of the motor increases. The amplitude decreasing means that the load torque applied to the rotor of the motor decreases.

In the first and second exemplary embodiments, the rotational velocity of the motor for driving the downstream conveying rollers is controlled, thereby differentiating the peripheral velocities of the downstream and upstream conveying rollers. The present disclosure, however, is not limited to this. For example, the rotational velocity of the motor for driving the upstream conveying rollers may be controlled, thereby differentiating the peripheral velocities of the downstream and upstream conveying rollers. Alternatively, the rotational velocities of both the motor for driving the upstream conveying rollers and the motor for driving the downstream conveying rollers may be controlled, thereby differentiating the peripheral velocities of the downstream and upstream conveying rollers.

The first and second exemplary embodiments are applied not only to motor control by vector control. For example, the first and second exemplary embodiments can be applied to any motor control device having a configuration for feeding back a rotational phase or a rotational velocity.

In the first and second exemplary embodiments, a stepper motor is used as a motor for driving a load. Alternatively, another motor such as a direct current (DC) motor may be used. Further, the motor is not limited to a two-phase motor, and the present exemplary embodiment can also be applied to another motor such as a three-phase motor.

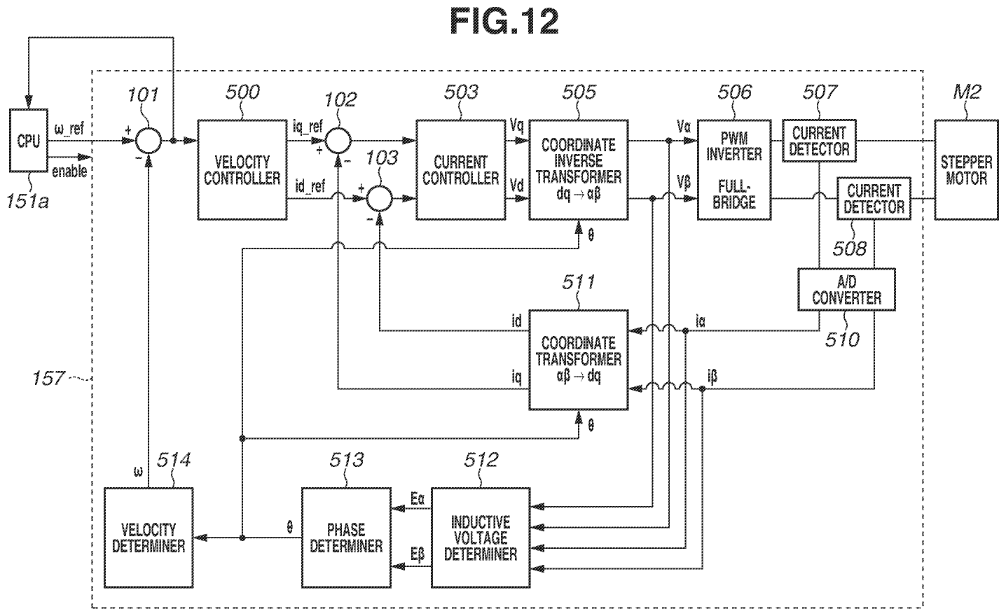

In the vector control according to the first and second exemplary embodiments, the motor is controlled by performing phase feedback control. The present disclosure, however, is not limited to this. For example, a configuration may be employed in which the motor is controlled by feeding back a rotational velocity ω of the rotor 402. Specifically, as illustrated in FIG. 12, a velocity determiner 514 is provided within the motor control device 157, and based on a change over time in the rotational phase θ output from the phase determiner 513, the velocity determiner 514 determines the rotational velocity ω. The velocity is determined using the following equation (10).

ω=dθ/dt (10)

Then, the CPU 151a outputs an instruction velocity ω_ref that indicates a target velocity of the rotor 402. Further, a configuration is employed in which a velocity controller 500 is provided within the motor control device 157. The velocity controller 500 generates the q-axis current instruction value iq_ref and the d-axis current instruction value id_ref such that the deviation between the rotational velocity w and the instruction velocity θ_ref becomes small. Then, the velocity controller 500 outputs the q-axis current instruction value iq_ref and the d-axis current instruction value id_ref. A configuration may be employed in which the motor is controlled by performing such velocity feedback control. In such a configuration, a sheet is detected by the methods described in the first and second exemplary embodiments, for example, based on a deviation Δω between the rotational velocity ω and the instruction velocity ω_ref. The instruction velocity ω_ref is a target velocity of the rotor 402 of the motor M2 corresponding to a target velocity of the peripheral velocity of the conveying rollers 306.

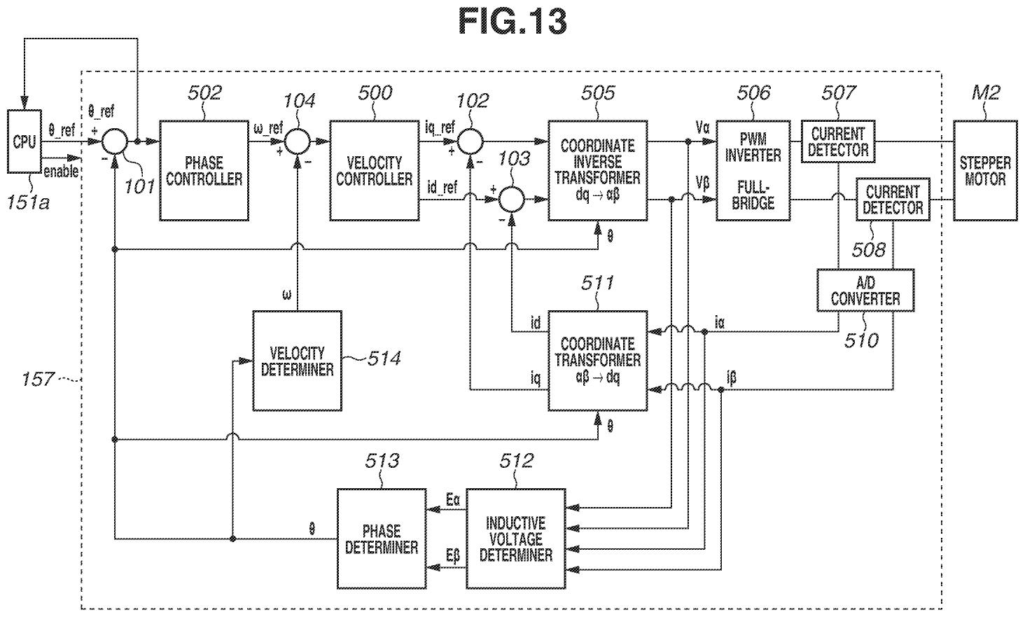

Further, for example, a configuration may be employed in which as illustrated in FIG. 13, the motor control device 157 performs both phase feedback control and velocity feedback control. In such a configuration, a sheet may be detected, for example, based on the deviation Δω between the rotational velocity ω and the instruction velocity ω_ref, or based on the deviation Δθ between the rotational phase θ and the instruction phase θ_ref. Alternatively, both the deviations Δω and Δθ may be used.

The deviations Δθ and Δω, the current values iq and iq_ref, and the amplitude of the current value iα or iβ in the stationary coordinate system correspond to the values of parameters corresponding to the load torque applied to the rotor of the motor. The values of the parameters corresponding to the load torque change when a sheet is conveyed by adjacent (adjoining) pairs of conveying rollers.

In the first and second exemplary embodiments, a permanent magnet is used as the rotor. The present disclosure, however, is not limited to this.

Further, the photosensitive drum 309, the developing device 314, and the transfer charging device 315 are included in an image forming unit.

Furthermore, a configuration may be employed in which the CPU 151a detects at least one of whether the front end of a sheet reaches a nip portion of conveying rollers, and whether the rear end of the sheet comes out of the nip portion of the conveying rollers.

Further, the configuration for detecting a sheet is also applied to, for example, a motor for driving a conveying belt to rotate. That is, the configuration for detecting a sheet is applied to a motor for driving a rotating member, such as a roller or a conveying belt, to rotate.

According to the present disclosure, it is possible to detect with high accuracy a sheet that is conveyed.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-160536, filed Aug. 29, 2018, which is hereby incorporated by reference herein in its entirety.

What is claimed is:

1. A sheet conveying apparatus comprising:
a first conveying roller configured to convey a sheet;
a second conveying roller adjacent to the first conveying roller and provided upstream of the first conveying roller in a conveying direction in which the sheet is conveyed;
a third conveying roller adjacent to the first conveying roller and provided downstream of the first conveying roller in the conveying direction;
a first motor configured to drive the first conveying roller;
a phase determiner configured to determine a rotational phase of a rotor of the first motor;
a controller configured to control a driving current flowing through a winding of the first motor, such that a deviation between the rotational phase determined by the phase determiner and an instruction phase indicating a target phase of the rotor is reduced; and
a discriminator configured to, based on the number of times an absolute value of a value of a parameter corresponding to a load torque applied to the rotor obtained while the driving current is controlled by the controller changes from a value smaller than a predetermined value to a value greater than the predetermined value, discriminate at least one of whether a front end of the sheet reaches a nip portion of the first conveying roller, and whether a rear end of the sheet passes through the nip portion of the first conveying roller.

2. The sheet conveying apparatus according to claim 1, wherein the controller controls the first motor such that a peripheral velocity of the first conveying roller is a peripheral velocity different from a peripheral velocity of the second conveying roller.

3. The sheet conveying apparatus according to claim 1, wherein the controller controls the first motor such that a peripheral velocity of the first conveying roller is a peripheral velocity different from a peripheral velocity of the third conveying roller.

4. The sheet conveying apparatus according to claim 1, wherein the discriminator discriminates that a (2*m+1)-th (m is an integer greater than or equal to 0) change in the absolute value of the value of the parameter corresponding to the load torque from the value smaller than the predetermined value to the value greater than the predetermined value after the driving of the first conveying roller is started, is a change due to the fact that the front end of the sheet reaches the nip portion of the first conveying roller.

5. The sheet conveying apparatus according to claim 1, wherein the discriminator discriminates that a 2*k-th (k is a positive integer) change in the absolute value of the value of the parameter corresponding to the load torque from the value smaller than the predetermined value to the value greater than the predetermined value after the driving of the first conveying roller is started, is a change due to the fact that the rear end of the sheet passes through the nip portion of the first conveying roller.

6. The sheet conveying apparatus according to claim 1, wherein the controller controls the driving current based on a torque current component that is a current component represented in a rotating coordinate system based on the rotational phase determined by the phase determiner and generates a torque in the rotor.

7. The sheet conveying apparatus according to claim 1, further comprising: a notification unit configured to, in a case where a state where the discriminator does not discriminate that the front end of the sheet reaches the nip portion of the first conveying roller continues for a predetermined time, make a notification that an abnormality occurs in the conveyance of the sheet.

8. The sheet conveying apparatus according to claim 1, further comprising: a second motor configured to drive the second conveying roller.

9. The sheet conveying apparatus according to claim 1, further comprising: a third motor configured to drive the third conveying roller.

10. The sheet conveying apparatus according to claim 1, wherein the parameter corresponding to the load torque is the deviation.

11. A sheet conveying apparatus comprising:
a first conveying roller configured to convey a sheet;
a second conveying roller adjacent to the first conveying roller and provided upstream of the first conveying roller in a conveying direction in which the sheet is conveyed;
a third conveying roller adjacent to the first conveying roller and provided downstream of the first conveying roller in the conveying direction;
a first motor configured to drive the first conveying roller;
a velocity determiner configured to determine a rotational velocity of a rotor of the first motor;
a controller configured to control a driving current flowing through a winding of the first motor, such that a deviation between the rotational velocity determined by the velocity determiner and an instruction velocity indicating a target velocity of the rotor is reduced; and
a discriminator configured to, based on the number of times an absolute value of a value of a parameter corresponding to a load torque applied to the rotor obtained while the driving current is controlled by the controller changes from a value smaller than a predetermined value to a value greater than the predetermined value, discriminate at least one of whether a front end of the sheet reaches a nip portion of the first conveying roller, and whether a rear end of the sheet passes through the nip portion of the first conveying roller.

12. The sheet conveying apparatus according to claim 11, wherein the controller controls the first motor such that a peripheral velocity of the first conveying roller is a peripheral velocity different from a peripheral velocity of the second conveying roller.

13. The sheet conveying apparatus according to claim 11, wherein the controller controls the first motor such that a peripheral velocity of the first conveying roller is a peripheral velocity different from a peripheral velocity of the third conveying roller.

14. The sheet conveying apparatus according to claim 11, wherein the discriminator discriminates that a (2*m+1)-th (m is an integer greater than or equal to 0) change in the absolute value of the value of the parameter corresponding to the load torque from the value smaller than the predetermined value to the value greater than the predetermined value after the driving of the first conveying roller is started, is a change due to the fact that the front end of the sheet reaches the nip portion of the first conveying roller.

15. The sheet conveying apparatus according to claim 11, wherein the discriminator discriminates that a 2*k-th (k is a positive integer) change in the absolute value of the value of the parameter corresponding to the load torque from the value smaller than the predetermined value to the value greater than the predetermined value after the driving of the first conveying roller is started, is a change due to the fact that the rear end of the sheet passes through the nip portion of the first conveying roller.

16. The sheet conveying apparatus according to claim 11, wherein the controller controls the driving current based on a torque current component that is a current component represented in a rotating coordinate system based on the rotational phase determined by the phase determiner and generates a torque in the rotor.

17. The sheet conveying apparatus according to claim 11, wherein in a case where a state where the discriminator does not discriminate that the front end of the sheet reaches the nip portion of the first conveying roller continues for a predetermined time, the conveyance of the sheet is stopped.

18. The sheet conveying apparatus according to claim 11, further comprising: a notification unit configured to, in a case where a state where the discriminator does not discriminate that the front end of the sheet reaches the nip portion of the first conveying roller continues for a predetermined time, make a notification that an abnormality occurs in the conveyance of the sheet.

19. The sheet conveying apparatus according to claim 11, further comprising: a second motor configured to drive the second conveying roller.

20. The sheet conveying apparatus according to claim 11, further comprising: a third motor configured to drive the third conveying roller.

21. The sheet conveying apparatus according to claim 11, wherein the parameter corresponding to the load torque is the deviation.

22. A sheet conveying apparatus comprising:
a first conveying roller configured to convey a sheet;
a first motor configured to drive the first conveying roller;
a first controller configured to feed back at least one of a rotational phase and a rotational velocity of a rotor of the first motor, thereby controlling a driving current flowing through a winding of the first motor;
a second conveying roller adjacent to the first conveying roller;
a second motor configured to drive the second conveying roller;
a second controller configured to feed back at least one of a rotational phase and a rotational velocity of a rotor of the second motor, thereby controlling a driving current flowing through a winding of the second motor; and
a discriminator configured to, based on both a value of a parameter corresponding to a load torque applied to the rotor of the first motor obtained by the feedback of the first controller and a value of a parameter corresponding to a load torque applied to the rotor of the second motor obtained by the feedback of the second controller, discriminate at least one of whether a front end of the sheet reaches a nip portion of the first conveying roller and whether a rear end of the sheet passes through the nip portion of the first conveying roller.

23. The sheet conveying apparatus according to claim 22, wherein a distance from a front end of an n+1-th sheet to a rear end of an n-th sheet is different in length from a distance between the nip portion of the first conveying roller and a nip portion of the second conveying roller, and
wherein a distance between the front end of the n+1-th sheet and a front end of the n-th sheet is different in length from a distance between the nip portion of the upstream conveying roller among the first and second conveying rollers and a nip portion of a third conveying roller adjacent to the downstream conveying roller among the first and second conveying rollers and provided downstream of the downstream conveying roller.

24. The sheet conveying apparatus according to claim 22, wherein a peripheral velocity of the first conveying roller is controlled to be a peripheral velocity different from a peripheral velocity of the second conveying roller.

25. The sheet conveying apparatus according to claim 22, further comprising: a first phase determiner configured to determine the rotational phase of the rotor of the first motor,
wherein based on a torque current component that is a current component represented in a rotating coordinate system based on the rotational phase determined by the first phase determiner and generates a torque in the rotor of the first motor, the first controller controls the driving current flowing through the winding of the first motor.

26. The sheet conveying apparatus according to claim 22, further comprising: a second phase determiner configured to determine the rotational phase of the rotor of the second motor,
wherein based on a torque current component that is a current component represented in a rotating coordinate system based on the rotational phase determined by the second phase determiner and generates a torque in the rotor of the second motor, the second controller controls the driving current flowing through the winding of the second motor.

27. A document reading apparatus comprising:
a first conveying roller configured to convey a sheet;
a second conveying roller adjacent to the first conveying roller and provided upstream of the first conveying roller in a conveying direction in which the sheet is conveyed;
a third conveying roller adjacent to the first conveying roller and provided downstream of the first conveying roller in the conveying direction;
a reading unit configured to read an image on the sheet conveyed by the third conveying roller;
a first motor configured to drive the first conveying roller;
a velocity determiner configured to determine a rotational velocity of a rotor of the first motor;
a controller configured to control a driving current flowing through a winding of the first motor, such that a deviation between the rotational velocity determined by the velocity determiner and an instruction velocity indicating a target velocity of the rotor is reduced; and
a discriminator configured to, based on the number of times an absolute value of a value of a parameter corresponding to a load torque applied to the rotor obtained while the driving current is controlled by the controller changes from a value smaller than a predetermined value to a value greater than the predetermined value, discriminate at least one of whether a front end of the sheet reaches a nip portion of the first conveying roller, and whether a rear end of the sheet passes through the nip portion of the first conveying roller.

28. A document reading apparatus comprising:
a first conveying roller configured to convey a sheet;
a second conveying roller adjacent to the first conveying roller and provided upstream of the first conveying roller in a conveying direction in which the sheet is conveyed;
a third conveying roller adjacent to the first conveying roller and provided downstream of the first conveying roller in the conveying direction;
an image forming unit configured to form an image on the sheet conveyed by the third conveying roller;
a first motor configured to drive the first conveying roller;
a velocity determiner configured to determine a rotational velocity of a rotor of the first motor;
a controller configured to control a driving current flowing through a winding of the first motor, such that a deviation between the rotational velocity determined by the velocity determiner and an instruction velocity indicating a target velocity of the rotor is reduced; and
a discriminator configured to, based on the number of times an absolute value of a value of a parameter corresponding to a load torque applied to the rotor obtained while the driving current is controlled by the controller changes from a value smaller than a predetermined value to a value greater than the predetermined value, discriminate at least one of whether a front end of the sheet reaches a nip portion of the first conveying roller, and whether a rear end of the sheet passes through the nip portion of the first conveying roller.
